(19) United States
(12) Patent Application Publication
(10) Pub. No.: US 2023/0416043 A1
(43) Pub. Date: Dec. 28, 2023

(54) AUTOMATIC THREAD REEL READING DEVICE WITH RFID TAG, RELATED SYSTEM AND TRACKING METHOD

(71) Applicant: THEMA 2 S.R.L., Moglia (Mantova) (IT)

(72) Inventor: Claudio MICHELINI, Moglia (Mantova) (IT)

(21) Appl. No.: 18/039,042

(22) PCT Filed: Dec. 23, 2021
(86) PCT No.: PCT/IB2021/062243

§ 371 Date: May 26, 2023

(30) Foreign Application Priority Data
Dec. 30, 2020 (IT) 102020000032810

(51) Int. Cl. B65H 67/06; G06K 7/10; G06K 19/077

(52) U.S. Cl. CPC B65H 67/063; G06K 7/10316; G06K 19/07758; B65H 2701/31

(57) ABSTRACT

An automatic reading device for tracking a reel of thread having a tube provided with an RFID tag is provided. The automatic reading device has a reader suitable for exchanging information with the RFID tag by an antenna and an electronic system having a central processing unit. The automatic reading device has a reel handling support having a tip on which a plurality of reels of thread having the tube provided with the RFID tag are insertable in sequence. The tip is the antenna.

The subject of this invention is an automatic system for tracking a reel of textile thread and a related method for automatically tracking the reel of thread using said system.

Even in the textile industry, due to the growing quality demands of the market, it has long been necessary to be able to provide the total traceability of the product, i.e., the ability to reconstruct the history of the finished textile product, whichever sector it refers to: clothing, home furnishings, automotive, etc., up to the origin of all the threads with which it was manufactured. The thread used is in turn the result of various steps and processes that together contribute to defining the quality features of the finished product.

In industrial production, the thread is wound onto a tube to form a reel using a machine called a winding machine. Essential in an industrial system is the automation of the process of moving the reels from the winding machine to the subsequent stages, such as the sorting line, the warehouse, or palletizing. In order to carry out these activities, the automatic handling systems include a machine called a “doffer” which is suitable to pick up the prepared reels of thread from the winders and transport them to the next station. For technical reasons, reels of thread must be able to be tracked and distinguished according to the production machine, production lot, and other quality-related parameters.

Currently, this tracking is done manually. The tube inside the reel is often made of cardboard, which provides a number of advantages such as low cost, good temperature resistance, the possibility of marking with symbols and colors and the ease of affixing tags therein.

In order to trace the path of the reels of thread, the most commonly used technology today involves the use of identification codes with graphic elements, such as a QR code or a bar code, applied internally to the tubes by directly marking the identification code or gluing on a tag containing said code.

However, this system still has some drawbacks: not only does it require the addition of a labeling station, but it also forces operators to use identification code recognition tools, which are sometimes difficult to locate inside the tube. For the same reason, automating the recognition of these tags is complex.

In order to have more and more automated and centrally controlled plants, it is necessary to be able to track the reels of thread automatically right from the start, i.e., from their exit from the winding machine.

The object of this invention is to solve problems associated with conventional thread reel tracking systems.

In particular, the object of this invention is to provide a system capable of fully automatic tracking of the reel of thread, immediately when it exits the winding machine.

This object is achieved by an automatic reading device for tracking reels of thread according to claim 1, a thread reel handling machine according to claim 6, an automatic thread reel tracking system according to claim 7, an automatic thread reel tracking method according to claim 8, a computer according to claim 12, and a computer program according to claim 13 to implement the automatic tracking method. The dependent claims describe preferred embodiments of the invention.

The features and advantages of the device according to this invention will appear more clearly from the following description, made by way of an indicative and non-limiting example with reference to the accompanying figures, wherein:

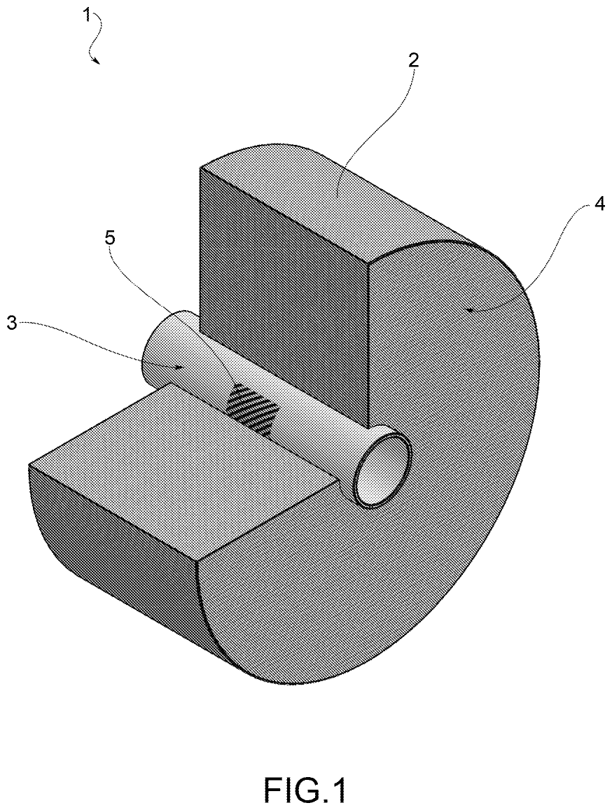

FIG. 1 shows an axonometric view of a reel of thread 1;

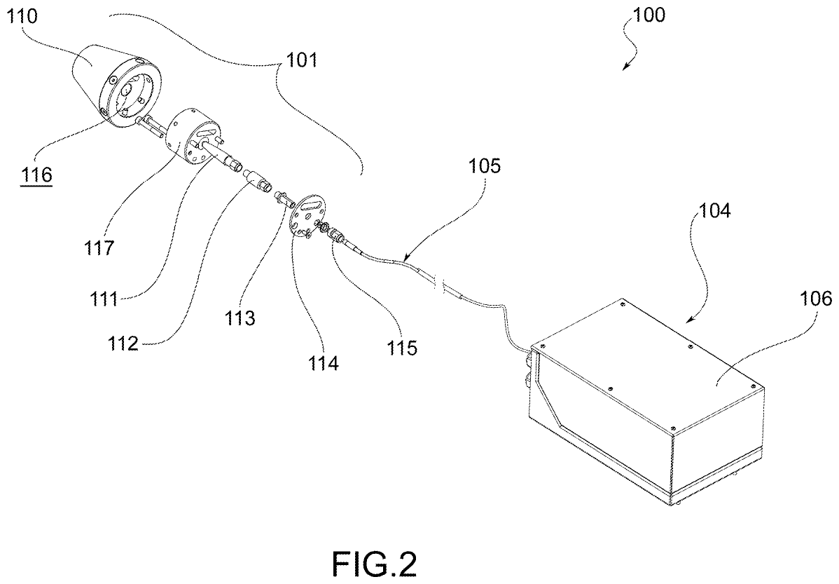

FIG. 2 shows an axonometric view of the automatic reading device 100 according to this invention, in particular an exploded view of the antenna 101 connected via the connection cable 105 to the electronic apparatus 104;

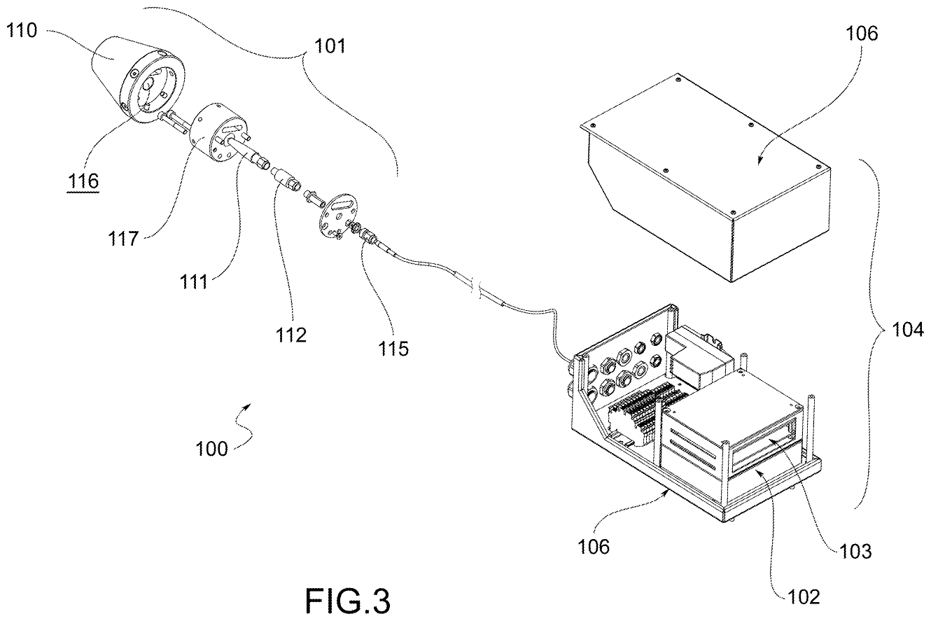

FIG. 3 shows the automatic reading device 100 of FIG. 2, wherein the casing of the electronic apparatus 104 has been partially removed;

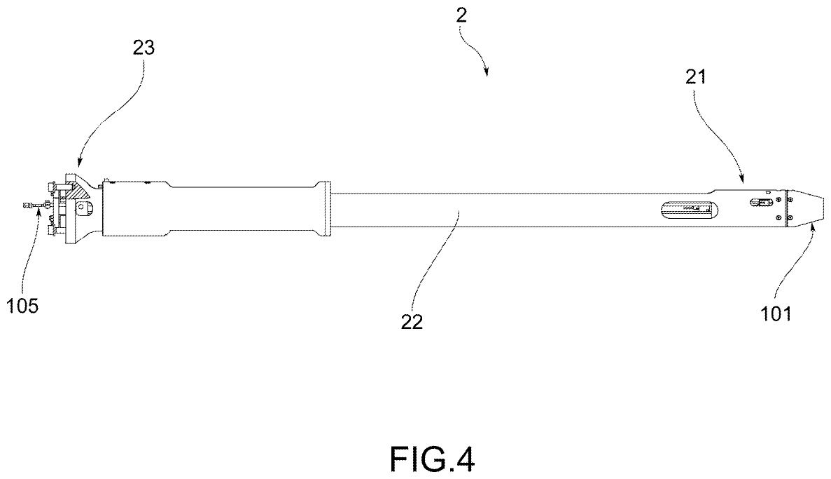

FIG. 4 shows a side view of a component of an automatic thread reel tracking machine 1 according to this invention, in particular of a reel handling support 2 having an automatic reading device 100 at the tip;

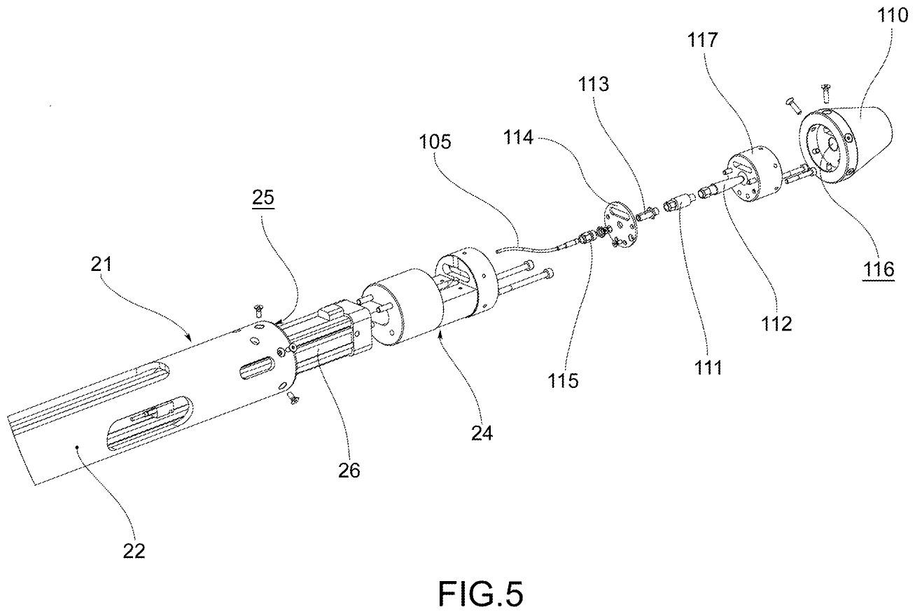

FIG. 5 shows an exploded view of the tip of the reel handling support in FIG. 4;

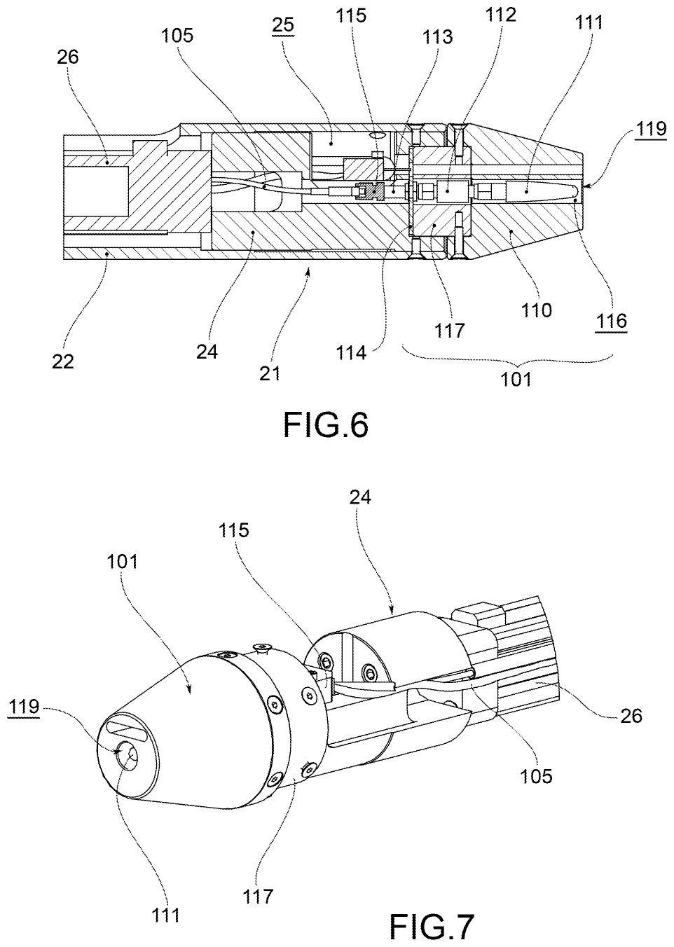

FIG. 6 shows a longitudinal sectional view of the tip of the reel handling support in FIG. 4;

FIG. 7 shows an axonometric view of the tip of the reel handling support in FIG. 4, after removal of the outer cover;

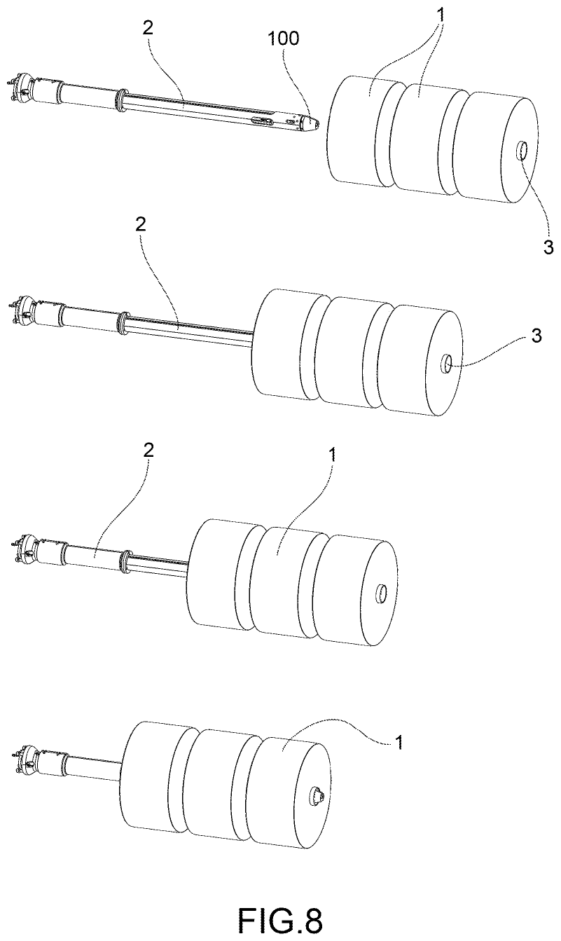

FIG. 8 shows a working diagram of the automation cycle for the automatic tracking of the reels of thread being loaded onto the reel handling support.

With reference to the above figures, in particular FIG. 1, some definitions useful for understanding the invention are given below.

Tube 3: cylinder on which thread is wound to form a reel of thread 1; often made of plastics or cardboard.

Reel of thread 1: is obtained by winding a thread accompanying it over a tube 3, maintaining a cylindrical symmetry. For mechanical-textile reasons, the reel of thread 1 may have different profiles depending on the physical-chemical nature of the thread collected.

RFID (Radio Frequency Identification): is the technology of automatic identification based on the propagation of electro-magnetic waves in the air, allowing the unambiguous, automatic (hands-free), massive and remote detection of objects, animals, and people both when static and in movement.

RFID TAG 5: also called a transponder or smart tag; its main component is a small silicon chip surrounded by an antenna, normally made of copper, to which it is connected and from which it receives the energy needed to operate when it is hit by an electromagnetic field of the appropriate frequency.

In summary therefore, as shown in FIG. 1, the reel of thread 1 comprises a tube 3 within which a tag 5 with RFID is affixed, allowing for unique identification of the tube 3 and thus the reel of thread 1.

In an example embodiment, the tag 5 (RFID TAG) is a unidirectional type, i.e., it may be read/written according to a specific orientation with respect to the antenna. The optimal position for the tag 5 is in the central band of the tube, so that it is as far away as possible from the tags 5 on neighboring tubes. However, this is not essential; the system is designed to work regardless. If the tag 5 is unidirectional, then the orientation must be defined; if the tag 5 is omnidirectional then the orientation does not affect the reading/writing of the tag.

In a further example embodiment, the tag 5 (RFID TAG) is of the omnidirectional type, i.e., it may be read/written regardless of the orientation of its plane with respect to the antenna. Advantageously, such a solution allows the RFID tag 5 to be attached in any position within the tube 3 and in any orientation.

A subject of this invention is an automatic tracking system comprising an automatic reading device 100, shown in FIGS. 2 and 4, and a plurality of tubes 3 having RFID tags 5, as in FIG. 1.

The automatic reading device 100 comprises an antenna 101, connected via a connection cable 105 to a reader 102 connected to an electronic system 103.

The antenna 101 converses with the antenna of the RFID tag 5 by means of radio waves.

Preferably, the antenna 101 is of the coaxial type, i.e., capable of receiving and emitting signals 3600 in a plane. Advantageously, such a solution, combined with the use of an omnidirectional RFID tag 5, ensures the certainty of reading the RFID tag 5 within a tube 3, and thus the certainty of tracking the reel of thread 1.

The reader 102 is suitable on the one hand to exchange information with the RFID tag 5 by means of the antenna 101, and on the other hand to interact with the electronic system 103 to which it is connected.

Thus, the reader 102 has the function of managing the antenna 101 that transmits and receives the radio frequency signals.

The electronic system 103 comprises a central processing unit (CPU) suitable to manage the sending of data read by the reader 102 to at least one programmable logic controller (PLC) and/or at least one computer via industrial serial protocols.

The reader 102 and the electronic system 103 to which it is connected are housed within an electronic apparatus 104, provided with a casing 106, which may be easily positioned in a workstation of the textile plant, for example on the “doffer” machinery which is adapted to pick up the reels of thread 1 from the winders and transport them to the next station.

The antenna 101 is shown specifically in FIGS. 2 and 3.

The antenna 101 comprises a head 110 within which a seat 116 is made in which an antenna body 111 is housed, which is suitable to read/write to the RFID tag 5 by means of radio waves.

Preferably, the seat 116 wherein the antenna body 111 is housed flows into a front opening 119.

Preferably, the head 110 is made of a non-shielding material, i.e., a material that does not interfere with electromagnetic fields, such as a plastics material.

Preferably, the head 110 has a frustoconical shape, with a smaller diameter toward the terminal end.

The head 110 is closed at the rear by a bushing 117 that also closes the seat 116 wherein the antenna body 111 is contained.

A screen 114 is arranged to the rear of the bushing 117. Preferably, the screen 114 is made of a shielding material, such as metal.

The antenna body 111 is connected at the rear to an attenuator 112 connected to an adapter 113 for the connection cable 105. Both the attenuator 112 and the adapter 113 are arranged within the bushing 117, which is closed at the rear by the screen 114.

Note that the adapter 113 protrudes from the screen 114.

The connection cable 105, which makes the data connection between the antenna 101 and the electronic apparatus 104 in which the reader 102 and the electronic system 103 are contained, comprises a connector 115 connectable to the adapter 113 of the antenna 101.

The automatic reading device 100 is characterized in that it comprises a reel handling support 2 having a tip 21, on which a plurality of reels of thread 1 are inserted in sequence, and in particular in that the tip 21 is the antenna 101.

The reel handling support 2 is thus provided with an antenna 101 at the tip 21.

Advantageously, the antenna 101 is designed to replace the tip of the reel handling support 2, so as not to compromise the proper operation of other standard electronic devices already on the support 2.

The reel handling support 2, shown in FIG. 4, comprises a reel handling support body 22 terminating on one side in a tip 21 through which the reels of thread 1 are loaded, and on the opposite side in a connection end 23 with the machine.

The hollow, circular-shaped reel handling support body 22 comprises, at the tip 21, an antenna seat 24 wherein the antenna 101 is at least partially inserted. For example, as in FIG. 6, the end portion of the antenna 101, namely the bushing 117 followed by the screen 114, is inserted into the antenna seat 24.

Preferably, the reel handling support body 22, at the tip 21, also houses within it a spacer 24 wherein the end portion of the connection cable 105 is housed, which has a connector 115 connectable to the adapter 113 of the antenna 101.

Preferably, the connection cable 105 runs internally to the reel handling support body 22 and exits from its connection end 23. Therefore, the electronic apparatus 104 of the automatic reading device 100 is arranged at the connection end 23 of the reel handling support 2.

Preferably, the connection cable 105 runs within a shielded tube, for example a metal tube, arranged within the reel handling support body 22.

Preferably, the reel handling support body 22 further accommodates reel pushing means 26 within it, for example in the form of a pneumatic cylinder.

A subject of this invention is also a machine for handling the reels of thread 1, shown at least partially in FIG. 4 through 7. Said machine comprises a plurality of reel handling supports 2 on which a series of reels of thread 1 having an RFID tag 5 inserted inside the tube 3 are loaded in sequence, starting from the tip 21. In particular, each reel handling support 2 is provided with an antenna 101 at the tip 21.

In one example embodiment, the machine is a “doffer” for picking up reels of thread 1 from the winders and transporting them to the next station.

Advantageously, the automatic reading device 100 according to this invention is sized, positioned, and set to read/write one RFID tag 5 at a time when the machine picks up/releases reels of thread 1 equipped with tubes 3 with RFID tags 5, all in an environment where tens of reels of thread 1 are found within a few meters.

An important step in the proper operation of the automatic reading device 100 is setting the antenna 101. In effect, the tubes 3 of the reels of thread have a predetermined length and as a function thereof the transmission power of the antenna signal is regulated. In effect, the automatic reading device 100 must read/write only one RFID tag 5 at a time and must do so only during the loading/unloading of the thread reel on the reel handling support 2.

A subject of this invention is also to provide a method for automatically tracking reels of thread 1.

The method according to this invention comprises at least the following steps:
providing at least one automatic reading device 100 as described above, i.e., having a reel handling support 2 with an antenna 101 at the tip 21;
tracking each reel of thread 1 that is inserted onto the reel handling support 2 using a tracking algorithm.

The tracking algorithm allows the input order of the reels 1 to be recognized when they are inserted onto the reel handling support 2.

In particular, the tracking algorithm is performed by a computer and includes at least the following steps of the AUTOMATION CYCLE:
1. at the beginning of the loading of the reels of thread 1 onto the reel handling support 2, starting a counter that samples the pulses of a clock; the number of reels of thread to be loaded is known (n=number of reels expected);
2. when loading the reels of thread 1 that are inserted onto the reel handling support 2, sampling the readings from each RFID tag 5 by means of the antenna 110;
3. after loading the reels of thread 1 onto the reel handling support 2, switching off the counter;
4. dividing the clocks counted by the number of expected reels and consequently defining the bands corresponding to each reel of thread 1 loaded:
a. first band →first reel;
b. second band →second reel;
. . .
n. nth band →last reel expected.

OPTIMAL CONDITION: If the antenna 101 was set correctly, i.e., so that only one RFID tag 5 is read at a time, and if the RFID tags 5 were positioned correctly in the tubes 3 so that they are read one at a time, then there will be a unique match between:
a. first band →first reel;
b. second band →second reel;
. . .
n. nth band →last reel expected.

IMPERFECT CONDITION: If the power of the antenna 101 was oversized or if two RFID tags 5 from two consecutive tubes 3 were placed close together, then the antenna 101 will simultaneously pick up the signal from two consecutive RFID tags 5 even if they are different.

Two corrective logics intervene in this condition:
a. acquisition order of the RFID tag 5;
b. clock interval in which the RFID tag is read.

FAILED OR MISSING RFID CONDITION: If the number of RFID tags 5 detected is less than the number of reels expected, and thus one or more RFID tags is faulty or missing, the software uses the clock interval as corrective logic to understand which is the missing tube in the a-n series.

It is also a subject of this invention to provide a computer programmed to implement the automatic tracking method of the reel of thread 1 as described above.

It is also a subject of this invention to provide a computer program comprising portions of code that, when the program is executed on a computer, implement the method for automatically tracking the reel of thread 1 as described above.

### Example (FIG. 8)

The software expects five reels of thread 1, and therefore five different RFID tag CODES, which by way of example shall be called STRING1, STRING2, STRING3, STRING4, STRING5.
RFID tag CODE TUBE 1: “STRING1”
RFID tag CODE TUBE 2: “STRING2”
RFID tag CODE TUBE 3: “STRING3”
RFID tag CODE TUBE 4: “STRING4”
RFID tag CODE TUBE 5: “STRING5”

The software does not know a priori the codes it is expecting, so it samples RFID tag readings at a set frequency.

| | | | CORRECT ORDER |
|---|---|---|---|
| OPERATION | SAMPLING | FAST COUNTER | RECONSTRUCTION |
| START SIGNAL | | COUNTER RESET | |
| | | 1 | TUBE 1 |
| TAG SAMPLE | — | 2 | |
| | | 3 | |
| TAG SAMPLE | STRING1 | 4 | |
| | | 5 | |
| TAG SAMPLE | STRING1 | 6 | |
| | | 7 | |
| TAG SAMPLE | STRING1 | 8 | |
| | | 9 | |
| TAG SAMPLE | — | 10 | |
| | | 11 | TUBE 2 |
| TAG SAMPLE | — | 12 | |
| | | 13 | |
| TAG SAMPLE | — | 14 | |
| | | 15 | |
| TAG SAMPLE | — | 16 | |
| | | 17 | |
| TAG SAMPLE | STRING 2 | 18 | |
| | | 19 | |
| TAG SAMPLE | STRING2 | 20 | |
| | | 21 | IMPERFECT CONDITION: |
| TAG SAMPLE | STRING2 | 22 | use of corrective |
| | | 23 | logic |
| TAG SAMPLE | STRING2-STRING3 | 24 | TUBE 3 |
| | | 25 | |
| TAG SAMPLE | STRING3 | 26 | |
| | | 27 | |
| TAG SAMPLE | — | 28 | |
| | | 29 | |
| TAG SAMPLE | — | 30 | |
| | | 31 | FAILURE OR MISSING |
| TAG SAMPLE | — | 32 | RFID CONDITION: use of |
| | | 33 | corrective logic |
| TAG SAMPLE | — | 34 | TUBE 4 |
| | | 35 | |
| TAG SAMPLE | — | 36 | |
| | | 37 | |
| TAG SAMPLE | — | 38 | |
| | | 39 | |
| TAG SAMPLE | — | 40 | |
| | | 41 | TUBE 5 |
| TAG SAMPLE | — | 42 | |
| | | 43 | |
| TAG SAMPLE | STRING5 | 44 | |
| | | 45 | |
| TAG SAMPLE | STRING5 | 46 | |
| | | 47 | |
| TAG SAMPLE | STRING5 | 48 | |
| | | 49 | |
| TAG SAMPLE | — | 50 | |
| END SIGNAL | | | |

The sum of the clocks obtained at the end of the detection, and thus at the end of the movement of loading the reels of thread 1 onto the reel handling support 2, is divided by the expected number of tubes 3. In this way, virtual bands are obtained (in the example above, five bands with a value of 10 clocks) in each of which the system waits for the detection of an RFID tag to be read.

The algorithm reconstructs the correct order of the RFID tags read following the first reading of the UNIQUE CODE associated with the tag.

Having a counter allows for imperfect or missing tube conditions or other inconsistencies to be recognized; in the example table, the detection of the RFID tag associated with the fourth reel of thread was absent.

The tracking system according to this invention provides for a data exchange with the automation system. The on-board electronic system is designed to exchange data with standard industry protocols with the outside. In this way it is possible to connect a PC and/or a PLC, and therefore a DATABASE.

The tracking system according to this invention also provides for the possibility of writing on the RFID tag of the tube 3. In this way, it is possible to trace the path of the reel of thread 1 in a more complete way, for example by writing the date and time of production, the machine and position of origin, the rise in production, etc.

Innovatively, a device 100 for automatically tracing a reel of thread 1, the related machine, the related system, and the related automatic tracing method, make it possible to automate the tracing of the path of the reel of thread 1 in an industrial plant, and thus make it objective and rapid.

Advantageously, the system according to this invention allows the automation system to maintain high performance because the “doffer,” equipped with a reel handling support with a device 100 for tracking, may;
continue to collect multiple reels of thread 1 at a time without having to slow down;
identify the RFID tag associated with the reel of thread 1 on the “doffer”;
recognize the order in which the reels enter the “doffer”;
allow data exchange with the system;
allow data to be written to the RFID tag memory.

It is understood that a person skilled in the art could make modifications to the product described above, all of which are contained within the scope of protection as defined by the following claims.

1-13. (canceled)

14. An automatic reading device for tracking a reel of thread comprising a tube provided with a radio frequency identification (RFID) tag, the automatic reading device comprising:
an antenna;
a reader connected to the antenna by a connection cable, adapted to exchange information with the RFID tag by the antenna;
an electronic system connected to the reader, comprising a central processing unit; and
a reel handling support provided with a tip on which a plurality of reels of thread comprising the tube provided with the RFID tag is insertable in sequence, wherein the tip is the antenna, and
wherein the antenna comprises a head provided with an internal seat in which an antenna body is accommodated, the internal seat being closed at the rear by a screen.

15. The automatic reading device of claim 14, wherein the antenna is coaxial, the antenna being adapted to receive and emit signals at 3600 on a plane.

16. The automatic reading device of claim 14, wherein the head is made of a non-shielding material and the screen is made of a shielding material.

17. The automatic reading device of claim 16, wherein the non-shielding material is plastic and the shielding material is metal.

18. The automatic reading device of claim 14, wherein the reel handling support comprises a cylindrical and hollow support body, and wherein the connection cable runs inside a shielded tube arranged inside the cylindrical and hollow support body and exits from a connection end.

19. The automatic reading device of claim 18, wherein the shielded tube is a metal tube.

20. A machine for handling reels of thread, comprising a plurality of automatic reading devices according to claim 14, wherein said machine is a doffer.

21. An automatic system for tracking a reel of thread, comprising:
an automatic reading device according to claim 14; and
a series of tubes for reels of thread, each of said tubes being provided with the RFID tag.

22. A method for automatic tracking of a reel of thread comprising a tube provided with a radio frequency identification (RFID) tag, the method comprising at least the following steps:
providing at least one automatic reading device comprising:
an antenna;
a reader connected to the antenna by a connection cable, adapted to exchange information with the RFID tag by the antenna;
an electronic system connected to the reader, comprising a central processing unit; and
a reel handling support provided with a tip on which a plurality of reels of thread comprising the tube provided with the RFID tag is insertable in sequence, wherein the tip is the antenna, and
wherein the antenna comprises a head provided with an internal seat in which an antenna body is accommodated, the internal seat being closed at the rear by a screen;
tracking each reel of thread inserted onto the reel handling support by a tracking algorithm;
wherein said tracking algorithm is run by a computer and includes at least the following steps:
a) at the start of loading of the reels of thread on the reel handling support, starting a counter that samples pulses of a clock;
b) while loading the reels of thread on the reel handling support, sampling readings of each RFID tag by the antenna; and
c) at the end of loading of the reels of thread on the reel handling support, switching off the counter and dividing counted clocks in step b) by the number of expected reels of thread, and defining clock ranges corresponding to each loaded reel of thread.

23. The method of claim 22, wherein the tracking algorithm further includes the following step, associated with an optimal condition in which the antenna has read only one RFID tag in a clock range:
associating a corresponding reel of thread to the clock range, on the basis of the RFID tag read.

24. The method of claim 22, wherein the tracking algorithm further includes the following step, associated with an imperfect condition in which the antenna has simultaneously read two different RFID tags in a same clock range:
associating a corresponding reel of thread to the clock range by applying at least one of the following corrective logics:
a. acquisition order of the RFID tag;
b. interval of clocks in which the RFID tag was read.

25. The method of claim 22, wherein the tracking algorithm further includes the following step, associated with a faulty or missing RFID condition in which the antenna has not read any RFID tag in a clock range:
associating a corresponding reel of thread to the clock range by applying the following corrective logic:
interval of clocks in which the RFID tag is missing.
